(19) United States
(12) Patent Application Publication
(10) Pub. No.: US 2004/0004607 A1
(43) Pub. Date: Jan. 8, 2004

(54) Image display element and image display device

(75) Inventors: Manabu Kodate, Shiga (JP); Hiroshi Nakashima, Shiga (JP)

Correspondence Address: FOLEY AND LARDNER, SUITE 500, 3000 K STREET NW, WASHINGTON, DC, 20007, US

(73) Assignee: CHI MEI OPTOELECTRONICS CORP.

(21) Appl. No.: 10/609,468

(22) Filed: Jul. 1, 2003

(30) Foreign Application Priority Data
Jul. 1, 2002 (JP) 2002-192650

(51) Int. Cl. G09G 5/00

(52) U.S. Cl. 345/204

(57) ABSTRACT

A surface wire that is connected to a scan line and the other surface wire that is connected to the other scan line via a thin-film transistor are arranged with a distance of at least 5 μm between these surface wires. Based on this structure, it is possible to prevent a current conduction between these surface wires due to impurity ions that is adhered to the surface wire while the power source is ON and that spreads while the power source is OFF. By suppressing a current leakage, it is possible to suppress the degradation of the screen display characteristics such as a color blur.

### BACKGROUND OF THE INVENTION

1) Field of the Invention

The present invention relates to an image display element and an image display device having a plurality of wires that are electrically connected to scan lines and are exposed.

2) Description of the Related Art

Progress in high resolution displays has accelerated dramatically through new technologies instead of a cathode ray-tube (CRT) display. Typical of the new technologies is a liquid-crystal display (hereinafter, “LCD”). The LCD is fabricated using fine processing, and thereby displays images in higher-definition than the CRT display.

Active-matrix TFT-LCD is known as a type of LCD. The active-matrix TFT-LCD uses a thin film transistor (hereinafter, “TFT”) as a switching element, and has a TFT array substrate and a counter substrate. The scan lines, the data lines, and a plurality of TFTs are arranged on the TFT array substrate. The scan lines and the data lines cross in matrix, and on each cross area of them, the TFT is arranged. The counter substrate is disposed across a space from the TFT array substrate. A liquid crystal material is filled in the space. Applying voltages to the liquid crystal through the TFT controlling allows images to be displayed, by the electro-optic effect.

FIGS. 15A to 15E illustrate a process of manufacturing a TFT array substrate. The TFT array substrate are fabricated with photolithography and etching processes using a plurality of masks each having different mask pattern. First, gate electrodes 101a and 101b are formed on a substrate (see FIG. 15A). Next, a gate insulation film 102, a semiconductor layer 103, and a channel protection layer 104 are formed (see FIG. 15B). Then, a drain electrode 105a and a source electrode 105b are formed (see FIG. 15C). After that, passivation layers 106a, 106b, and 106c are formed (see FIG. 15D). Finally, surface wires 107a and 107b are formed (see FIG. 15E). The surface wire 107b connects between a terminal connecting a scan line and another surface wire or an electrode. The number of the masks does not depend on structure of the TFTs on the TFT array substrate, and is only five.

However, this five mask process leads to the surface wire 107b the surface of which is exposed, as shown in FIG. 15E. The exposed surface of the surface wire 107b causes the screen display characteristics of the LCD to degrade. Specifically, unevenness of the image, such as a color blur, is observed in display areas including surface wires corresponding to the surface wire 107b. The degradation of the screen display characteristics is little observed immediately after the LCD is manufactured. However, the degradation becomes gradually obvious based on the aging. After the LCD is used over a long period, the screen display characteristics are degraded to a visible level.

On the other hand, the degradation of the screen display characteristics is not observed in a LCD not having such exposed surface wires which are connected to the scan lines. Therefore, the degradation is considered to be attributable to the presence of the surface wire 107b. Consequently, from the viewpoint of avoiding the degradation of the characteristics, it is preferable that surface wires that are connected to the scan lines are disposed in an internal area other than the surface of the TFT array substrate. For this purpose, it is necessary to increase the number of manufacturing steps. The increase in the number of manufacturing steps is not preferable from the viewpoint of manufacturing cost.

### SUMMARY OF THE INVENTION

It is an object of the present invention to at least solve the problems in the conventional technology.

The image display element according to one aspect of the present invention includes a plurality of data lines to which display signals are applied, the data lines being embedded in a substrate; a plurality of scan lines to which display signals are applied, the scan lines being embedded in the substrate; a first wire having a surface which is exposed, the first wire being electrically connected to one of the scan lines; and a second wire having a surface which is exposed, wherein a distance between the first wire and the second wire is more than or equal to 5 μm.

The image display element according to another aspect of the present invention includes a plurality of data lines to which display signals are applied, the data lines being embedded in a substrate; a plurality of scan lines to which scan signals are applied, the scan lines being embedded in the substrate; a first wire having a surface which is exposed, the first wire being electrically connected to one of the scan lines; a second wire having a surface which is exposed, the second wire being arranged in the vicinity of the first wire; and an insulator that is arranged to cover the surface of at least one of the first and second wires.

The image display element according to still another aspect of the present invention includes a first substrate; a plurality of data lines to which display signals are applied, the data lines being embedded in the first substrate; a plurality of scan lines to which display signals are applied, the scan lines being embedded in the first substrate; a wire having a surface which is exposed, the wire being electrically connected to one of the scan lines; a second substrate that is arranged opposite to the first substrate, with a distance from the first substrate; and a spacer that is mounted on any one of the first substrate and the lower surface of the second substrate, with a distance of at least 5 μm from the wire, and that prescribes a distance between the first substrate and the second substrate.

The image display device according to still another aspect of the present invention is that includes an image display area having M×N pixels in a matrix shape, on a substrate, where M and N are positive integer. The image display device employs the image display element according to the present invention.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic view of a structure of a TFT array substrate of a first embodiment according to the present invention;

FIG. 2 is an equivalent circuit diagram of a wiring structure of a display area S shown in FIG. 1;

FIG. 3 is a timing diagram that shows the operation of an image display device of the first embodiment;

FIG. 4 is a top plan view of an actual structure of the equivalent circuit shown in FIG. 2;

FIG. 5 is a cross-sectional view that shows a cross-sectional structure of an area D shown in FIG. 4;

FIGS. 6A to 6C are schematic views that describe a current leakage that occurs in a conventional LCD apparatus;

FIG. 7 shows an LCD of a second embodiment according to the present invention;

FIG. 8 shows a modification of the LCD of the second embodiment;

FIGS. 9A to 9D illustrate a process of disposing a light-shield film on the TFT array substrate;

FIG. 10 is a cross-sectional view of the conventional LCD that describes a positional relationship between a surface wire and a spacer;

FIG. 11 illustrates a diagram to explain a current leakage that occurs between the surface wire and a common electrode in the conventional LCD apparatus;

FIG. 12 is a top plan view of an image display device of a third embodiment according to the present invention that describes dispositions of a TFT array substrate and spacers that are mounted on the TFT array substrate;

FIG. 13 is a top plan view of a modification of the image display device of the third embodiment;

FIG. 14 is a top plan view of another modification of the image display device of the third embodiment; and

FIGS. 15A to 15E illustrate a process of manufacturing a TFT array substrate in the conventional LCD apparatus.

### DETAILED DESCRIPTION

Exemplary embodiments of the image display element and the image display device relating to the present invention will be explained in detail below with reference to the accompanying drawings. In the drawings, identical or like portions are attached with identical or like reference symbols or numerals. The drawings are schematic views, and they do not exactly show real portions, and include portions that have different size relations or size ratios between the drawings.

An image display apparatus of a first embodiment will be explained first. The image display apparatus of the first embodiment has a structure of an LCD and selects one pixel from a plurality of scan lines. However, the present invention can be applied to all image display devices that have a structure that a part of surface wires electrically connected to the scan lines is exposed.

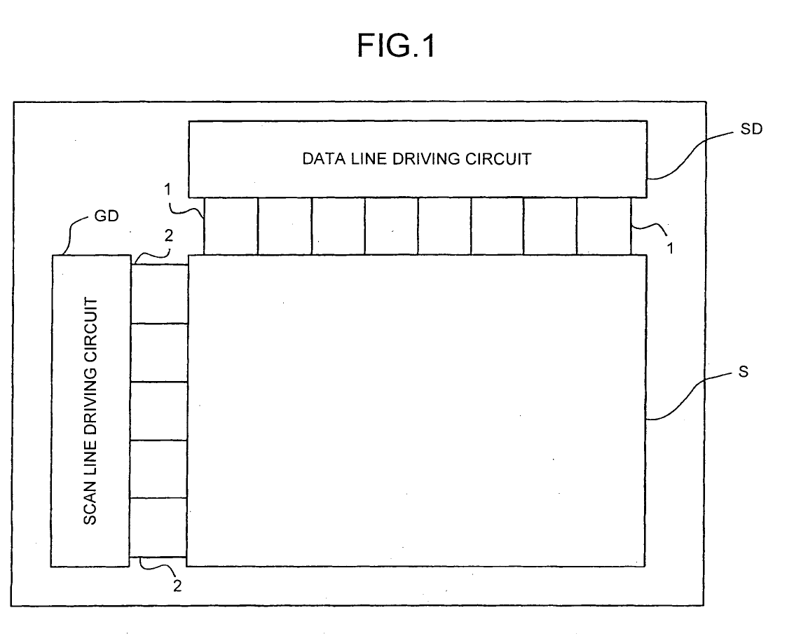

FIG. 1 is a schematic view of a structure of a TFT array substrate that constitutes the image display apparatus of the first embodiment. The image display apparatus includes various devices, such as a color filter substrate that faces the TFT array substrate, and a back light unit, other than the TFT array substrate. However, since these devices are not characteristic parts of the present invention, the explanation of the parts will be omitted.

As shown in FIG. 1, the TFT array substrate includes a data line driving circuit SD connected to a plurality of data lines 1, a scan line driving circuit GD connected to a plurality of scan lines 2, and a display area S. The data line driving circuit SD supplies display signals to pixel electrodes, which are disposed within a display area S, via that data lines 1. In other words, the data line driving circuit SD applies voltages to the pixel electrodes. The scan line driving circuit GD supplies scan signals for on-off switching of TFTs via the scan lines 2. Within the display area S, M×N pixels are arranged in a matrix shape, where M is the number of data lines, N is the number of scan lines.

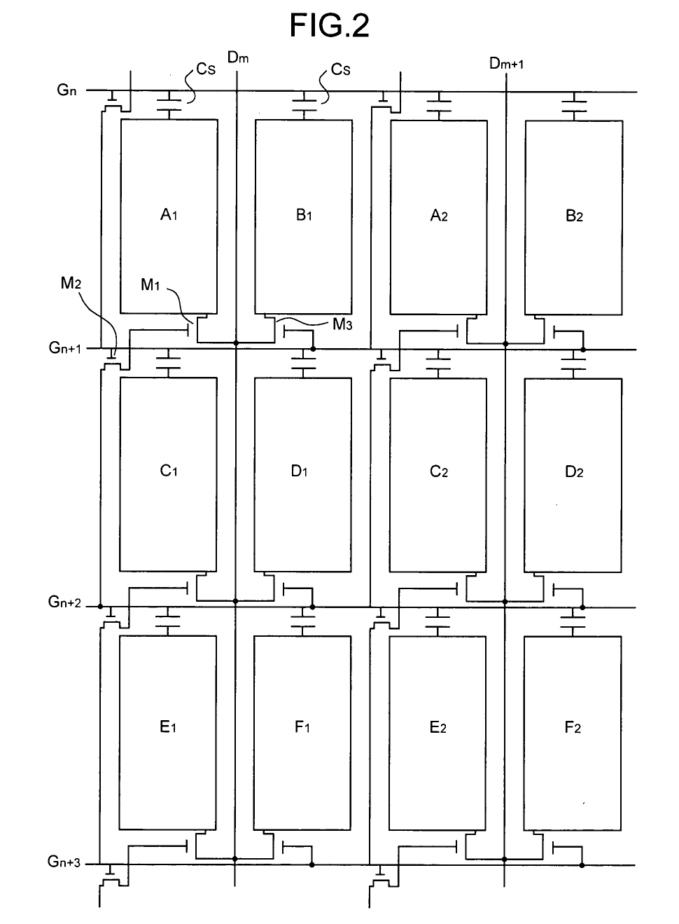

FIG. 2 is an equivalent circuit diagram of a part of the structure within the display area S on the TFT array substrate. As shown in FIG. 2, for a pixel electrode A1 and a pixel electrode B1 that are adjacently disposed by sandwiching a data line Dm between them, three TFTs including a TFT M1, a TFT M2, and a TFT M3 are disposed as follows.

The TFT M1 has its source electrode connected to the data line Dm, and has its drain electrode connected to the pixel electrode A1. The TFT M1 has its gate electrode connected to the source electrode of the TFT M2. Each TFT is a switching element that has three terminals. In the TFT, its source electrode is connected to a data line, and its drain electrode is connected to a pixel electrode, or vice versa. In the following description, the source electrode and the drain electrode each will be referred as “source/drain electrode”.

The TFT M2 has its one source/drain electrode connected to the gate electrode of the TFT M1, and has the other source/drain electrode connected to a scan line Gₙ₊₂. Therefore, the gate electrode of the TFT M1 is connected to the scan line Gₙ₊₂ via the TFT M2. The TFT M2 has its gate electrode connected to a scan line Gₙ₊₁. Therefore, only during a period while a scan signal with a selective potential is applied to two adjacent scan lines Gₙ₊₁ and Gₙ₊₂ by the scan line driving circuit GD, the TFT M1 is “on”, and the potential of the data line Dₘ is supplied to the pixel electrode A1. This means that the TFT M2 controls “on” and “off” of the TFT M1.

The TFT M3 has its one source/drain electrode connected to the data line Dₘ, and has the other source/drain electrode connected to the pixel electrode B1. The TFT M3 has its gate electrode connected to the scan line Gₙ₊₁. Therefore, when a scan signal with a selective potential is applied to the scan line Gₙ₊₁, the TFT M3 is “on”, and the potential of the data line Dₘ is supplied to the pixel electrode B1. This wiring structure similarly applies to other pixel electrodes and other TFTs.

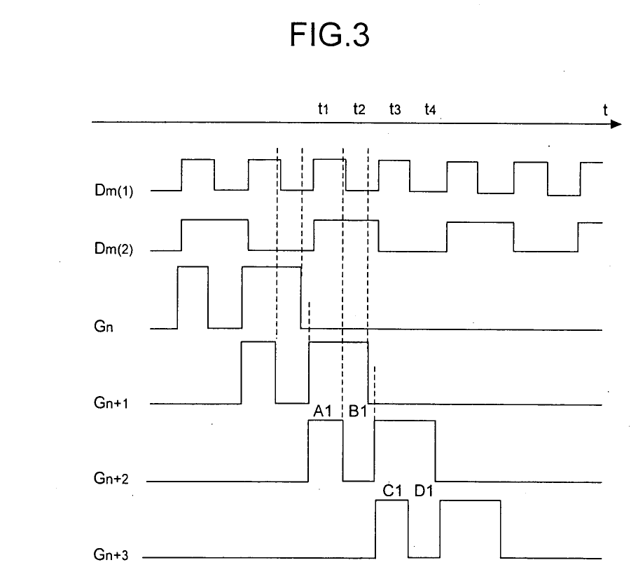

The operation of the TFT array substrate that has a structure as shown in FIG. 1 and FIG. 2 will be explained below. FIG. 3 is a timing diagram of scan signals and display signals.

In FIG. 3, Dₘ (1) and Dₘ (2) simply show potentials of display signals transmitted to the data line Dₘ. Signals transmitted to the data line Dₘ actually have different potentials depending on polarity and gradation of the pixel. In FIG. 3, however, the different potentials are illustrated as only two levels, for easily understanding the signal timing. Therefore, from the viewpoint of a change in polarity, when the display signal Dₘ (1) is transmitted to the data line Dₘ, the polarities of the pixel electrode A1 and the pixel electrode B1 are different, and the polarities of the pixel electrode A1 and the pixel electrode C1 are the same. On the other hand, when the display signal Dₘ (2) is transmitted to the data line Dₘ, the polarities of the pixel electrode A1 and the pixel electrode B1 are the same, and the polarities of pixel electrode A1 and the pixel electrode C1 are the different. In FIG. 3, the timing diagrams of the scan lines Gₙ to Gₙ₊₃ shows selection and a non-selection states of the scan line Gₙ. Specifically, a high level period between the leading edge and the trailing edge of a pulse shows a state that the scan line is selected, and the other low level period shows a state that the scan line is not selected.

During a period of t1, which is from when a selective potential is applied to both the scan lines Gₙ₊₁ and Gₙ₊₂ to when a non-selective potential is applied to the scan line Gₙ₊₂, the TFT M1, M2, and M3 are “on”. During this period t1, a potential V1a is applied to the pixel electrode A1 via the data line Dₘ. As a result, the potential of the pixel electrode A1 is determined.

After the non-selective potential is applied to the scan line Gₙ₊₂, a display signal with a potential V1b is applied to the pixel electrode B1 via the data line Dₘ, thereby to determine the potential of the pixel electrode B1. As shown in FIG. 3, during a period of t2 in which the non-selective potential is applied to the scan line Gₙ₊₂ after the period t1, the selective potential is applied to the scan line Gₙ₊₁. Consequently, the TFT M1 becomes “off”, and the TFT M3 becomes “on”. Therefore, no potential is applied to the pixel electrode A1, and a potential is continuously applied to the pixel electrode B1 via the data line Dₘ, thereby to determine the potential of the pixel electrode B1.

During a period of t3 after the non-selective potential is applied to the scan line Gₙ₊₁, a potential V1c is applied to the data line Dₘ, and the selective potential is applied to the scan lines Gₙ₊₂ and Gₙ₊₃. As a result, the potential V1c is applied to the pixel electrode C1 and a pixel electrode D1 via the data line Dₘ, thereby to determine the potential of the pixel electrode C1. Thereafter, the scan lines are sequentially selected by the selective potential, and a potential (i.e., display signal) based on the scan line selected is applied to the data line Dₘ, thereby to determine the potentials of the adjacent pixel electrodes that sandwich the data line Dₘ. After that, the data line driving circuit SD switches from the data line Dₘ to the data line Dₘ₊₁. The potentials of the scan lines are sequentially switched in a similar manner to that explained above, thereby to determine the potentials of the pixel electrodes A2 and B2, the pixel electrodes C2 and D2, and the pixel electrodes E2 and F2 respectively that sandwich the scan line Dₘ₊₁. By repeating the above operation, the potentials of all the pixel electrodes in the display area S are determined. As a result, an image is displayed based on the electro-optic effect of the liquid crystal layers that are arranged on the TFT array substrate.

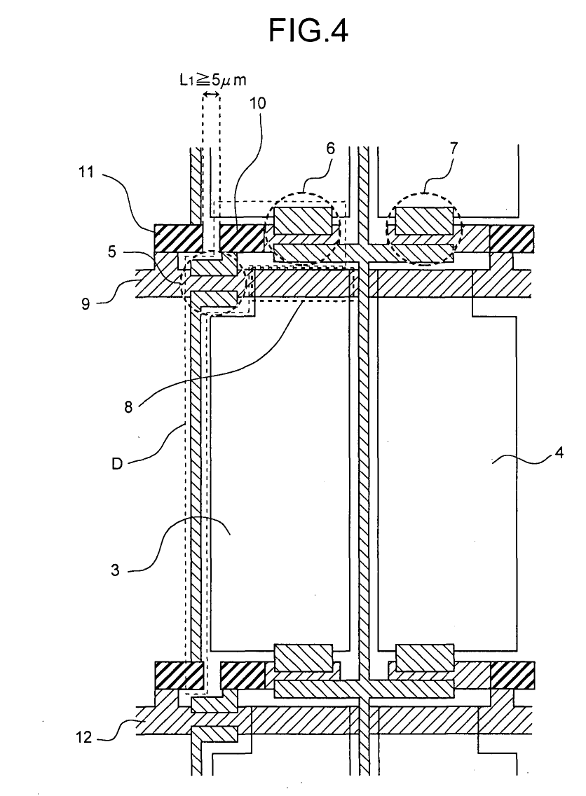

An actual wiring structure that realizes the equivalent circuit shown in FIG. 2 will be explained below. FIG. 4 is a top plan view of a part of the wiring structure in the display area S that constitutes the TFT array substrate. When a pixel electrode 3 corresponds to the pixel electrode C1 shown in FIG. 2, a pixel electrode 4 corresponds to the pixel electrode D1, and TFTs 5, 6, and 7 correspond to the TFT M1, the TFT M2, and the TFT M3 respectively. A storage capacitor 8 is formed in an area where the pixel electrode 3 and a scan line 9 (corresponding to the scan line Gₙ₊₁ in FIG. 2) are superimposed with each other.

A source/drain electrode of the TFT 5 and the gate electrode of the TFT 6 are connected to each other via a surface wire 10 the surface of which is exposed. A surface wire 11 the surface of which is exposed is connected to the scan line 9, and is arranged in the vicinity of the surface wire 10. In the image display device of the first embodiment, a distance L₁ between the surface wire 10 and the surface wire 11 is set to at least 5 μm. Similarly, a distance between other surface wires on the TFT array substrate is set to at least 5 μm. In the first embodiment, degradation of the screen display characteristics is suppressed, by determining a distance between the adjacent surface wires, as explained in detail later.

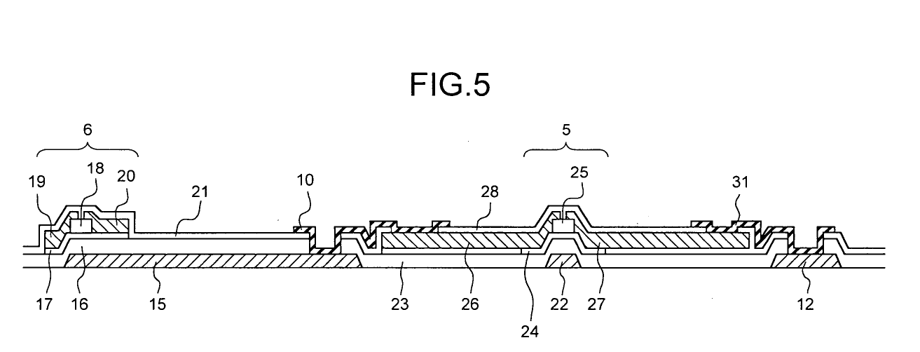

FIG. 5 shows a cross-sectional view of an area D shown in FIG. 4. As shown in FIG. 5, the TFT M1 has a part of a metal area that extends to a horizontal direction as a gate electrode 15. A gate insulating film 16, a channel layer 17, a channel protection layer 18, and source/drain electrodes 19 and 20 are sequentially laminated on the gate electrode 15. The exposed surface of the laminated structure is covered with a passivation film 21. Similarly, the TFT M2 has a part of the scan line Gₙ₊₁ (i.e., the scan line 9) as a gate electrode 22. A gate insulation film 23, a channel layer 24, a channel protection layer 25, and source/drain electrodes 26 and 27 are sequentially laminated on the gate electrode 22. The exposed surface of this laminated structure is covered with a passivation film 28. The surface wire 10 is formed so that its surface is exposed, to connect between the gate electrode 15 of the TFT 6 and the source/drain electrode 26 of the TFT 5. Similarly, the surface wire 31 is formed so that its surface is exposed, to connect between the source/drain electrode 27 of the TFT 5 and the scan line 12.

This surface wiring structure is required from the viewpoint of simplifying the manufacturing process, and the surface wires cause the degradation of the screen display characteristics, as explained in the conventional technique. In the image display device of the first embodiment, the distance between the surface wires (hereinafter, “surface wire distance”) is set to at least 5 μm so as to prevent the degradation. Reasons for the degradation of the screen display characteristics in the conventional LCD having such surface wires will be explained below. Then, reasons why the image display device of the first embodiment can suppress the degradation will be explained.

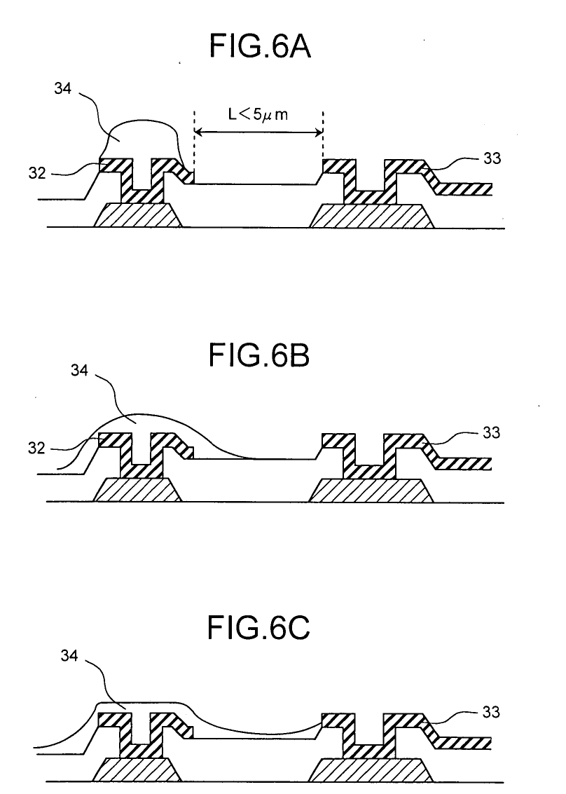

From studies of the degradation of the screen display characteristics due to the surface wiring structures in the conventional LCD apparatus, the inventors of the present invention found that a current leakage between the surface wires is one of causes of the degradation. FIGS. 6A to 6C are schematic views that describe a state that the current leakage occurs between the surface wires when a surface wire distance L is smaller than 5 μm. In FIGS. 6A to 6C, it is assumed that a surface wire 32 is connected to a scan line, and a surface wire 33 is not connected to any scan lines, in order to facilitate the explanation. However, this assumption is not excluding a surface wiring structure that both surface wires 32 and 33 are connected to the scan lines, and the surface wiring structure that the surface wires 10 and 11 are connected to the scan lines 12 and 9, respectively, as shown in FIG. 4.

In general, in an LCD that employs an n-channel TFT as a switching device, the TFT is “on” only when a potential is applied to the pixel electrode. In other words, the TFT is “off” for most of the period. Therefore, in the “off” state, the potential of its gate electrode is at a low value, and the potential of the scan line that controls the potential of the gate electrode also becomes low. This is clear from the timing diagram shown in FIG. 3. For example, the potential of the scan line Gₙ₊₂ is the selective potential only during the period that potentials of the pixel electrodes A1, C1, and D1 are determined. During other period, the these electrodes maintain the non-selective potential until when the same pixel is selected again in the next frame.

Therefore, when an impurity to be ionized to a cation is mixed into a liquid-crystal layer, the cation is gravitated to the surface wire 32. This is because the surface wire 32 is connected to the gate electrode the potential of which is a lower than the surrounding, and therefore has a relatively negative potential. The cation is adhered to the surface wire 32 or an orientation film that is in contact with the surface wire 32, and thereby an ion layer 34 is formed (see FIG. 6A). During a period while the power source of the LCD is off, the potential of the surface wire 32 becomes equivalent to that of the surrounding. Therefore, the ion layer 34 having been formed spreads on the surface of the TFT array substrate (see FIG. 6B). Thereafter, the ion layer 34 further spreads over the surrounding of the ion layer 34, with the use of the LCD over a long time. Lastly, the ion layer 34 becomes a conducting path between the surface wires 32 and 33 that are originally insulated from each other. That is, a current leaks to the conducting path.

This conducting path causes the potentials of the scan line and the data line to change from a desired value. Consequently, the amount of charge supplied to the pixel electrode becomes smaller than the desired one. As a result, a color blur is observed in the display area corresponding to the pixel electrode, which degrades the screen display characteristics.

The above fact coincides with a fact that an impurity gradually penetrates into a liquid-crystal layer during a lapse of a long period of time since the manufacturing of the LCD that has the surface wiring structure, although the mixing of an impurity is suppressed at the beginning after the manufacturing. Further, a fact that the degradation of the screen display characteristics noticeably appears at the periphery of the screen display area also coincides with the penetration of an impurity from the periphery.

In order to prevent the current leakage resulting from the impurity ion, it is effective to separate between the surface wires by not less than a predetermined distance. In the first embodiment, as shown in FIG. 4, the surface wire distance is set to at least 5 μm which is determined from measurements by the inventors. From an acceleration test under the surface wire distance of 6 μm and the same conditions other than the surface wire distance, a slight degradation of the screen display characteristics is observed. However, it is possible to suppress the degradation to a level of practicably no problem. From another acceleration test under the surface wire distance of 10 μm and the same conditions other than the surface wire distance, no degradation of the screen display characteristics is observed, and it is possible to maintain satisfactory screen display characteristics. Therefore, when the surface wire distance is at least 5 μm, it is possible to suppress the degradation of the screen display characteristics due to the current leakage.

It is possible to easily realize this structure by adjusting the positions of the surface wires at a design stage. The surface wiring structure, in general, makes the manufacturing of the TFT array substrate complex. However the adjustment of the positions of the surface wires does not require a further manufacturing process. It is possible to manufacture the image display device of the first embodiment based on the same process as that used conventionally, except that mask patterns are changed following the design. Therefore, this image display device can maintain high screen display characteristics during long-term use, without further complex manufacturing process.

An image display device of a second embodiment according to the present invention will be explained next. In the image display device of the second embodiment, among a plurality of adjacent surface wires, at least one surface wire is covered with an insulator. Like in the first embodiment, this image display device will be explained based on the structures shown in FIG. 1 to FIG. 3. It is of course possible to apply the second embodiment to a general image display device other than the above structures.

When an insulating film may be formed on the surface wires, it is possible to suppress the current leakage on the surface of the TFT array substrates that constitutes the image display device. However, the formation of such an insulating film, in general, requires a further manufacturing process. On the contrary, In the display image apparatus of the second embodiment, the surface wires is covered with an insulator without a further manufacturing process.

In the following explanation, a pair of adjacent surface wires have a distance of not larger than 5 μm between them. As explained above, when the adjacent surface wires have a distance of at least 5 μm between them, it is not necessary to cover the surface wires with an insulator to maintain the screen display characteristics. However, at least one of a pair of surface wires which are separated from each other by at least 5 μm may be covered with the insulator.

One example of the insulator is a spacer which is originally provided in the image display device. The spacer basically prescribes a distance between a TFT array substrate and a counter substrate that is disposed oppositely, and maintains a thickness of a liquid crystal layer at a constant level. This image display device differs from the conventional LCD in that the spacer is mounted on the surface wire to be covered. As a result of this arrangement of the spacer, the surface wire isolates from a liquid crystal layer, and thereby it is possible to suppress the degradation of the screen display characteristics.

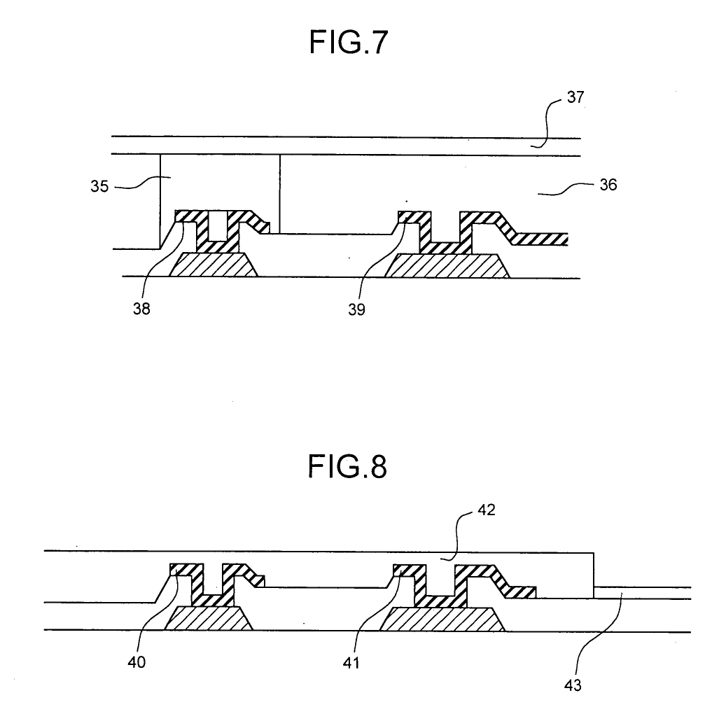

FIG. 7 is a schematic view of a structure that a spacer is mounted on a surface wire. As shown in FIG. 7, the surface wire 38 that is connected to scan line is mounted with a spacer 35 so that the surface wire 38 is not directly in contact with a liquid layer 36. As a result, even when the liquid-crystal layer 36 contains impurity ions and also when a lower potential is applied to the surface wire, the impurity ions do not adhere to the surface wire. Thus, it is possible to prevent the occurrence of the current leakage between the surface wire 38 and the other adjacent surface wire 39 through the impurity ions. Therefore, it is possible to suppress the degradation of the screen display characteristics.

Since the spacer 35 is originally provided in the image display device, it is possible to realize the structure shown in FIG. 7 by only adjusting the position of the spacer 35, without a further manufacturing process for forming the spacer. Therefore, the image display device having a structure that the spacer 35 is mounted on the surface wire 38 out of the adjacent surface wires as shown in FIG. 7 can maintain high screen display characteristics without a further manufacturing process. Such a spacer may also be mounted on not only the surface wire 38 but also the surface wire 39.

It is preferable that the spacer is a pillar-shaped one. The pillar-shaped spacer is formed according to a photolithography after a film is formed with a predetermined material over the whole surface of the counter substrate or the TFT array substrate. Therefore, by adjusting mask patterns, it is possible to easily realize a structure that has the spacer mounted on the surface wire. The pillar-shaped spacer may be formed not by the photolithography but by other method that is capable of controlling mounting position of the spacer. The pillar-shaped spacer may be made of a material of a color filter.

Another example of the insulator is a light-shield film that disposed on the TFT array substrate. The light-shielding film (so-called “black matrix”) is provided to improve a contrast of a display image, and to prevent the irradiation of external light onto channel layers of the TFTs. Usually, the light-shield film is disposed on the counter substrate. By disposing the light-shield film on the TFT array substrate, it is possible to suppress the degradation of the screen display characteristics.

FIG. 8 is a schematic view of a structure that a light-shield film 42 is mounted on a surface wire. The light-shield film 42 makes an aperture in an area corresponding to a pixel electrode 43, thereby to prevent a transmission of light in other areas than this. Since the surface wire is disposed between adjacent pixel electrodes, surface wires 40 and 41 are covered with the light-shield film 42, and are isolated from a liquid-crystal layer. Therefore, it is possible to prevent impurity ions from adhering to the surface wires 40 and 41, thereby to prevent the current leakage. As a result, it is possible to restrict a variation in the potential that is applied to the pixel electrode 43.

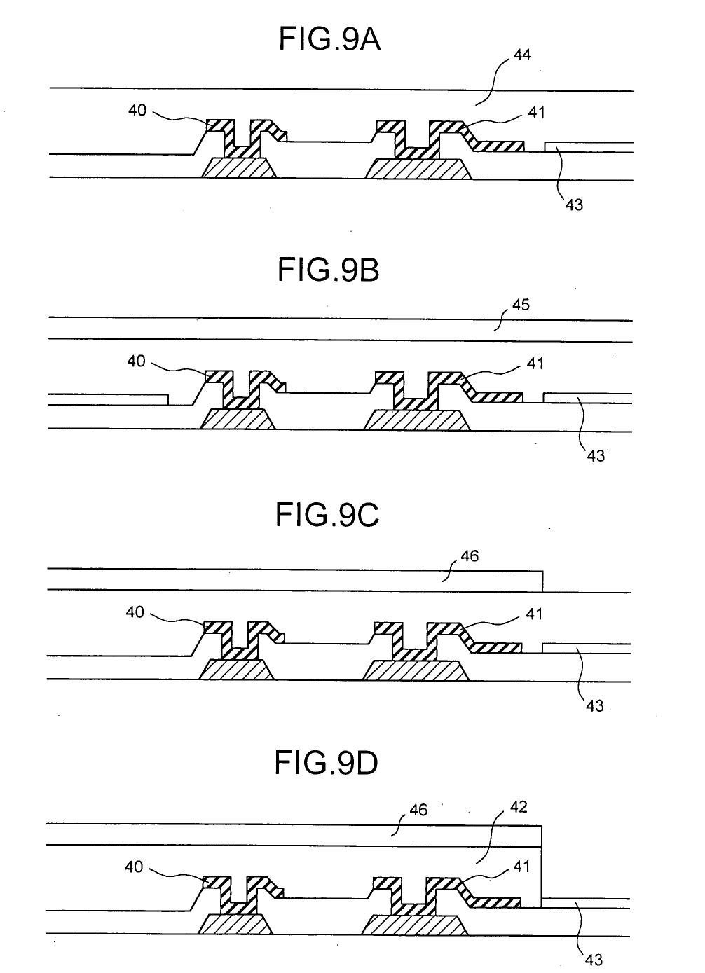

FIGS. 9A to 9D show one example of a process of forming a light-shield film on a TFT array substrate. First, as shown in FIG. 9A, based on a sputtering or the like, a predetermined material is used to form a uniform film, thereby to form an insulating layer 44, on the surface of a TFT array substrate that is formed with pixel electrodes and surface wires.

As shown in FIG. 9B, a photo-resist layer 45 is coated onto the insulating layer 44 based on a spin coating or the like. The insulating layer 44 coated with the photo-resist layer 45 is exposed by using a pattern having an aperture in an area corresponding to the pixel electrode 43, and is then developed, thereby to form a mask pattern 46 as shown in FIG. 9C.

After that, as shown in FIG. 9D, the insulating layer 44 is etched by using the mask pattern 46, thereby to form the light-shield film 42. The mask pattern 46 remaining on the light-shield film 42 is removed. As a result, it is possible to obtain the structure shown in FIG. 8. If a photo-resist having light-shielding characteristic is formed on the TFT array substrate in place of the insulating layer 44, it is possible to omit some steps shown in FIGS. 9A to 9D.

The steps shown in FIGS. 9A to 9D are similar to the conventional steps of manufacturing a LCD apparatus, except that a substrate on which a film is formed is different. Therefore, it is possible to use a conventional manufacturing apparatus in order to realize the structure shown in FIG. 8. When the light-shield film 42 is disposed on the TFT array substrate as shown in FIG. 8, usually it is not necessary to dispose a light-shield film on the counter substrate. Therefore, it is possible to suppress the degradation of the image display characteristics without increasing the total number of manufacturing steps.

An image display device of a third embodiment according to the present invention will be explained next. The image display device of the third embodiment also has a structure of selecting one pixel by using a plurality of scan lines. It is also possible to apply the present invention to other image display device that has the surface wires, like in the first embodiment.

In addition to the degradation of the image display characteristics due to the current leakage between the adjacent surface wires, the inventors found that a current leakage could occur between the surface wire and an electrode (e.g., a common electrode) that is disposed on the counter substrate. Reasons for the occurrence of this current leakage will be explained below. Then, a structure for suppressing the current leakage will be explained.

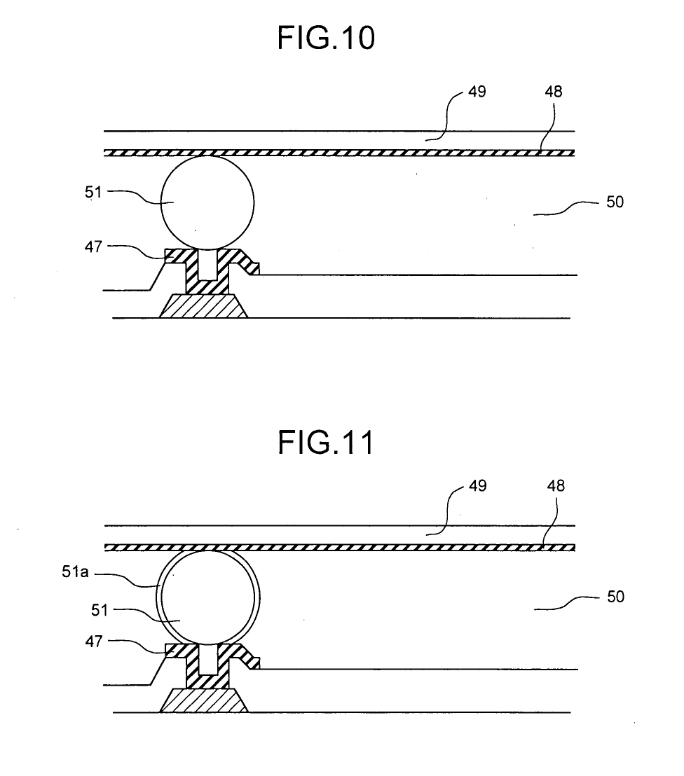

FIG. 10 is a schematic view of a cross-sectional structure of a conventional LCD apparatus. A surface wire 47 is disposed on a TFT array substrate. Opposite to the TFT array substrate, a counter substrate 49 that has a common electrode 48 on its surface is disposed. A liquid-crystal layer 50 is sealed into between the TFT array substrate and the counter substrate 49. A spacer 51 is disposed to prescribe a distance between the TFT array substrate and the counter substrate 49.

The conventional LCD does not particularly take into account a disposition of the spacer 51 that prescribes the distance between the TFT array substrate and the counter substrate 49. When a spherical spacer is used as the spacer 51, it is not possible to control the position of the spacer, in the conventional LCD apparatus. Therefore, according to the conventional LCD apparatus, the surface wire 47 and the spacer 51 are brought into contact with each other in some cases, as shown in FIG. 10. The spacer 51 is formed with a silica material or the like, and therefore, does not have current conductivity. However, it is known that, during a long use of the LCD apparatus, an adhesion or an adsorption of impurity ions occurs on the surface of the spacer 51 or on the surface of an orientation film that is adhered to the surface of the spacer 51. Therefore, as shown in FIG. 11, adsorbed ions form a conductive layer 51a, which makes the surface wire 47 and the common electrode 48 conductive. As a result, a leaked current flows between the surface wire 47 and the common electrode 48. As explained above, an impurity gradually penetrates into a liquid-crystal layer during a use of the image display device over a long term, and impurity ions is generated. The impurity ions are adsorbed on the spacer 51, which generates a current leakage. As a result, the image display characteristics are degraded. Therefore, in the image display device of the third embodiment, a position between the surface wire and the spacer is prescribed, thereby to suppress the current leakage between the surface wire 47 and the common electrode 48.

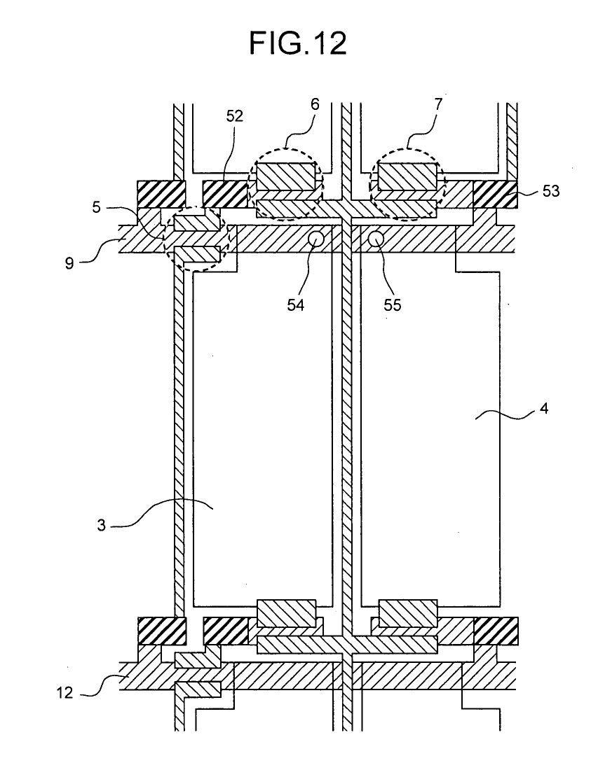

FIG. 12 is a top plan view of the image display device of the third embodiment that shows positions of a TFT array substrate and spacers that are mounted on the TFT array substrate. In this image display device, a distance L2 between a surface wire 52 that is connected to a scan line or has a potential equivalent to that of the scan line and a spacer 54 is set to at least 5 μm. A distance between a surface wire 53 and a spacer 55 is also set to at least 5 μm.

The distance between the surface wire and the spacer is set to at least 5 μm based on a result of experiments. The inventors carried out acceleration tests of an image display device by setting a distance between the surface wire and the spacer to 0 μm, 6 μm, and 16 μm. As a result of the experiments, in the image display device that has 0 μm for the distance between the surface wire and the spacer, degradation of the image display characteristics is obviously observed. On the other hand, in the image display device that has 6 μm for the distance, a slight degradation of the image display characteristics is observed. However, it is possible to suppress the degradation to a level of practicably no problem. In the image display device that has 16 μm for the distance, no degradation of the screen display characteristics is observed. Therefore, the inventors set at least 5 μm for distance at which it is possible to suppress the degradation of the image display characteristics.

In order to dispose the spacer at the above position, in the third embodiment, the space is a pillar-shaped one. As explained above, when a pillar-shaped spacer is used, it is possible to control the position of the spacer in high precision, and it is possible to set the distance between the surface wire and the spacer to a desired level.

It is preferable that the spacer is positioned on a light-shield area. The light-shield area refers to an area where light that is input to the TFT array substrate is not transmitted. As shown in FIG. 12, the scan line 9 is disposed in the area where the spacers 54 and 55 are mounted, and corresponding data lines are formed with a light-shield metal layer. Therefore, the light that is input to the TFT array substrate is shielded, and is not transmitted.

Reasons for mounting the spacers 54 and 55 on the light-shield area will be explained. An orientation film not shown is disposed on the TFT array substrate. In general, this orientation film prescribes the orientation of liquid-crystal molecules that form a liquid-crystal layer. In order to prescribe the orientation of the liquid-crystal molecules, a processing such as rubbing is carried out to the orientation film. However, this processing may generate a disturbance in the molecular structure on the surface of the orientation film in the vicinity of the spacer. Further, this processing may generate a disturbance in the orientation of the liquid-crystal molecules. Because of these disturbances, when the spacer is mounted on the light transmission area, the screen display characteristics may be degraded due to reasons different from the current leakage. Therefore, from the viewpoint of reducing the possibility of the degradation of the screen display characteristics, it is preferable that the spacer is mounted on the light-shield area.

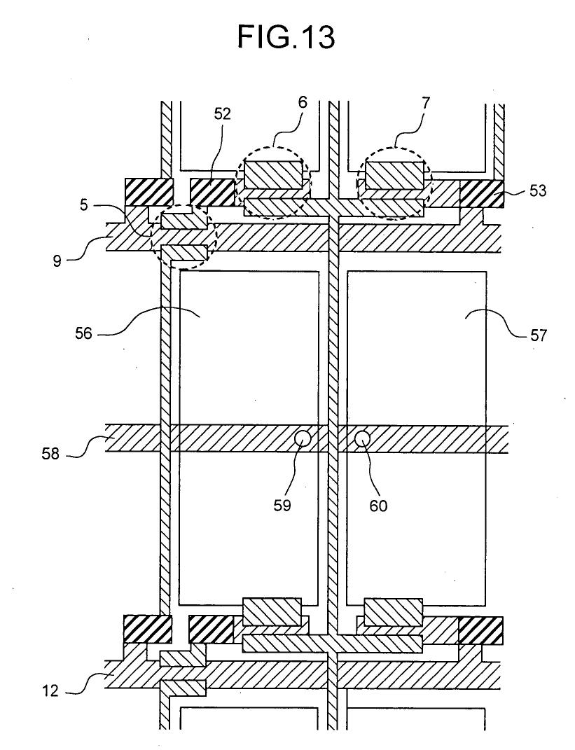

By changing the structure of the TFT array substrate, it is also possible to mount the spacer on an area other than the scan line 9. FIG. 13 is a top plan view of a modified structure of the TFT array substrate and the spacer that is mounted on the TFT array substrate. As shown in FIG. 13, in the modified structure, the pixel electrodes 56 and 57 have rectangular shapes, and a capacitor line 58 is provided in a layer lower than the pixel electrodes 56 and 57. A storage capacitor is formed in an area where the capacitor line 58 and the pixel electrodes 56 and 57 are superimposed with each other. The spacers 59 and 60 are mounted on the capacitor line 58.

The capacitor line 58 is formed with a light-shield metal layer like the data line. In the area where the capacitor line 58 is disposed, light that is input to the TFT array substrate shown in FIG. 13 is shielded. Therefore, although the spacers 59 and 60 are mounted on the pixel electrodes 56 and 57, the image display characteristics are not degraded due to the disturbance in the orientation of the liquid-crystal molecules.

As is clear from the comparison between FIG. 12 and FIG. 13, in the modified example, it is possible to take a large distance between the surface wire and the spacer. Therefore, based on the structure shown in FIG. 13, it is possible to suppress more effectively the degradation of the image display characteristics due to the current leakage.

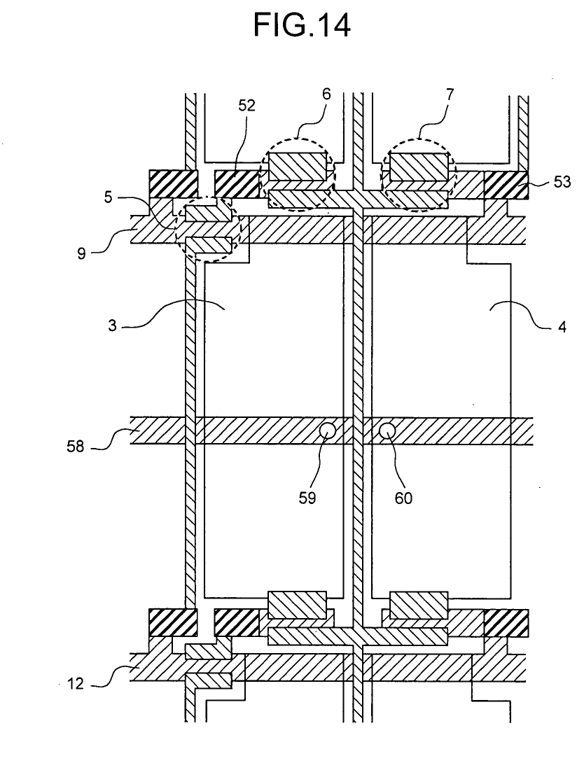

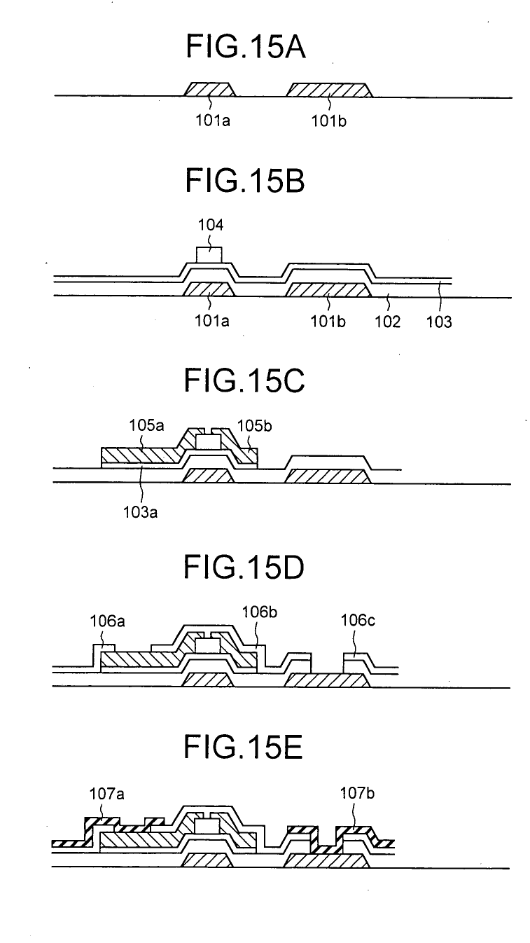

As a second modification, it is effective to provide a structure that has an area in which the pixel electrode and the data line are superimposed with each other, and that has a capacitor line. FIG. 14 is a top plan view of a structure that has an area in which the pixel electrodes 3 and 4 are superimposed with the scan line 9, and that has the capacitor line 58. As shown in FIG. 14, as the pixel electrodes are superimposed with the scan line 9 and the capacitor line 58, it is possible to increase the storage capacitor. Therefore, it is possible to further avoid variations in the potentials of the pixel electrodes, and it is possible to control the pixel potentials in high precision. This is a large advantage for picture quality, and it is possible to provide a high-quality image. In the TFT array substrate shown in FIG. 14, it is possible to dispose the spacer by isolating it from the surface wire, like in the examples shown in FIG. 12 and FIG. 13. As a result, it is possible to suppress a current leakage between the common electrode provided on the surface of the counter substrate and the surface wire, and it becomes possible to suppress the degradation of the screen display characteristics.

While the image display devicees of the first to third embodiments according to the present invention have been explained above, the present invention is not limited to these embodiments. A person skilled in the art could easily conceive of various embodiments and modifications based on the above embodiments. For example, in the circuit wiring on the TFT array substrate shown in FIG. 2, a structure is employed in which a data line and a plurality of scan lines give potentials to adjacent pixel electrodes that sandwich the same data line. However, the application of the present invention is not limited to this wiring structure. It is possible to apply the present invention to the image display device that has a plurality of surface wires regardless of a driving system and a wiring structure.

While the example of covering the insulating material on the surface wire is explained in the second embodiment, the insulating material may be provided on both adjacent surface wires instead of on only one of the adjacent surface wires. When a surface wire that is connected to a scan line and a surface wire that is not connected to a scan line are adjacent to each other, it is possible to suppress a current leakage by covering one of the surface wires. Therefore, this surface wiring structure is also effective from the viewpoint of suppressing the degradation of the screen display characteristics.

In order to suppress the current leakage explained in the third embodiment, it is also effective to employ the structure shown in the first embodiment. For example, a spacer mounted on the light-shield film that is disposed on the TFT array substrate and a surface wire are electrically insulated from each other. Therefore, even when impurity ions are adsorbed on the surface of the spacer, a common electrode disposed on a counter substrate and a surface wire are not conductive to each other. It becomes possible to suppress not only a current leakage between the adjacent surface wires but also a current leakage between the common electrode and the surface wire.

It is also effective to combine the structures explained in the first to third embodiments. For example, when a distance between surface wires is set to at least 5 μm and also when a distance between a surface wire and a spacer is set to at least 5 μm, it becomes possible to suppress a current leakage between surface wires and a current leakage between a surface wire and a common electrode disposed on a counter substrate. Therefore, by employing this structure, it becomes possible to effectively suppress the degradation of the screen display characteristics.

As explained above, according to the present invention, in an image display element and an image display device that employ surface wires respectively, there is an effect that it is possible to suppress a current leakage due to the presence of the surface wires. It is possible to maintain high screen display characteristics without increasing the load on the manufacturing process.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image display element, comprising:
a plurality of data lines to which display signals are applied, the data lines being embedded in a substrate;
a plurality of scan lines to which scan signals are applied, the scan lines being embedded in the substrate;
a first wire having a surface which is exposed, the first wire being electrically connected to one of the scan lines; and
a second wire having a surface which is exposed, wherein a distance between the first wire and the second wire is more than or equal to 5 μm.

2. The image display element according to claim 1, wherein
a potential of the second wire is substantially equal to a potential of a scan line other than the one scan line.

3. The image display element according to claim 1, further comprising:
a first pixel electrode and a second pixel electrode that are supplied with display signals from one of the data lines;
a first switching device that controls a supply of the display signal in the one data line, wherein the first switching device is electrically connected between the one data line and the first pixel electrode and that has a gate electrode;
a second switching device that is electrically connected between the gate electrode of the first switching device and one scan line; and
a third switching device that is connected to the one data line and that controls a supply of the display signal to the second pixel electrode.

4. An image display element, comprising:
a plurality of data lines to which display signals are applied, the data lines being embedded in a substrate;
a plurality of scan lines to which scan signals are applied, the scan lines being embedded in the substrate;
a first wire having a surface which is exposed, the first wire being electrically connected to one of the scan lines;
a second wire having a surface which is exposed, the second wire being arranged in the vicinity of the first wire; and
an insulator that is arranged to cover the surface of at least one of the first and second wires.

5. The image display element according to claim 4, wherein
a potential of the second wire is substantially equal to a potential of a scan line other than the one scan line.

6. The image display element according to claim 4, further comprising:
a counter substrate that is disposed opposite to the substrate, with a distance from the substrate, wherein
the insulator is a spacer that prescribes the distance.

7. The image display element according to claim 4, wherein
the insulator is a light-shield film that has a light transmission area.

8. The image display element according to claim 4, further comprising:
a first pixel electrode and a second pixel electrode that are supplied with display signals from one of the data lines;
a first switching device that controls a supply of the display signal in the one data line, wherein the first switching device is electrically connected between the one data line and the first pixel electrode and that has a gate electrode;
a second switching device that is electrically connected between the gate electrode of the first switching device and one scan line; and
a third switching device that is connected to the one data line and that controls a supply of the display signal to the second pixel electrode.

9. An image display element, comprising:
a first substrate;
a plurality of data lines to which display signals are applied, the data lines being embedded in the first substrate;
a plurality of scan lines to which scan signals are applied, the scan lines being embedded in the first substrate;
a wire having a surface which is exposed, the wire being electrically connected to one of the scan lines;
a second substrate that is arranged opposite to the first substrate, with a distance from the first substrate; and
a spacer that is mounted on any one of the first substrate and the lower surface of the second substrate, with a distance of at least 5 μm from the wire, and that prescribes a distance between the first substrate and the second substrate.

10. The image display element according to claim 9, wherein
the spacer is arranged on a light-shield area.

11. The image display element according to claim 9, wherein
the spacer is arranged on a light-shield area, at a position with a largest distance from the wire.

12. The image display element according to claim 9, further comprising:
a first pixel electrode and a second pixel electrode that are supplied with display signals from one of the data lines;
a first switching device that controls a supply of the display signal in the one data line, wherein the first switching device is electrically connected between the one data line and the first pixel electrode and that has a gate electrode;
a second switching device that is electrically connected between the gate electrode of the first switching device and one scan line; and
a third switching device that is connected to the one data line and that controls a supply of the display signal to the second pixel electrode.

13. An image display device, comprising:
a data line driving circuit that supplies a display signal to a plurality of data lines;
a scan line driving circuit that supplies a scan signal to a plurality of scan lines;
a first wire having a surface which is exposed, the first wire being electrically connected to one of the scan lines; and
a second wire having a surface which is exposed, wherein a distance between the first wire and the second wire is more than or equal to 5 μm.

14. The image display device according to claim 13, wherein
a potential of the second wire is substantially equal to a potential of a scan line other than the one scan line.

15. The image display device according to claim 13, further comprising:
a first pixel electrode and a second pixel electrode that are supplied with a display signal from a same data line;
a first switching device that controls the supply of the display signal from the data line to the first pixel electrode, and that is driven based on a scan signal supplied from a first scan line;
a second switching device that controls a supply of the display signal from the data line to the second pixel electrode, and that is driven based on a scan signal supplied from a second scan line subsequent to the first scan line; and
a third switching device that is driven based on the scan signal supplied from the first scan line, and that controls ON and OFF of the second switching device.

16. An image display device, comprising:
a data line driving circuit that supplies a display signal to a plurality of data lines;
a scan line driving circuit that supplies a scan signal to a plurality of scan lines;
a first wire having a surface which is exposed, the first wire being electrically connected to one of the scan lines;
a second wire having a surface which is exposed, the second wire being arranged in the vicinity of the first wire; and
an insulator that is arranged to cover the surface of at least one of the first and second wires.

17. The image display device according to claim 16, wherein
a potential of the second wire is substantially equal to a potential of a scan line other than the one scan line.

18. The image display device according to claim 16, further comprising:
a first pixel electrode and a second pixel electrode that are supplied with a display signal from a same data line;
a first switching device that controls the supply of the display signal from the data line to the first pixel electrode, and that is driven based on a scan signal supplied from a first scan line;
a second switching device that controls a supply of the display signal from the data line to the second pixel electrode, and that is driven based on a scan signal supplied from a second scan line subsequent to the first scan line; and
a third switching device that is driven based on the scan signal supplied from the first scan line, and that controls ON and OFF of the second switching device.

19. An image display device, comprising:
a data line driving circuit that supplies a display signal to a plurality of data lines;
a scan line driving circuit that supplies a scan signal to a plurality of scan lines;
a first substrate;
a plurality of data lines to which display signals are applied, the data lines being embedded in the first substrate;
a plurality of scan lines to which scan signals are applied, the scan lines being embedded in the first substrate;
a wire having a surface which is exposed, the wire being electrically connected to one of the scan lines;
a second substrate that is arranged opposite to the first substrate, with a distance from the first substrate; and
a spacer that is mounted on any one of the first substrate and the lower surface of the second substrate, with a distance of at least 5 μm from the wire, and that prescribes a distance between the first substrate and the second substrate.

20. The image display device according to claim 19, further comprising:
a first pixel electrode and a second pixel electrode that are supplied with a display signal from a same data line;
a first switching device that controls the supply of the display signal from the data line to the first pixel electrode, and that is driven based on a scan signal supplied from a first scan line;
a second switching device that controls a supply of the display signal from the data line to the second pixel electrode, and that is driven based on a scan signal supplied from a second scan line subsequent to the first scan line; and
a third switching device that is driven based on the scan signal supplied from the first scan line, and that controls ON and OFF of the second switching device.
